(19) United States
(12) Patent Application Publication
(10) Pub. No.: US 2013/0067408 A1
(43) Pub. Date: Mar. 14, 2013

(54) CONTEXTUALLY APPLICABLE COMMANDS

(71) Applicants: Jan-Kristian Markiewicz, Redmond, WA (US); Gerrit Hendrik Hofmeester, Woodinville, WA (US); Jon Gabriel Clapper, Seattle, WA (US); Adam George Barlow, Redmond, WA (US)

(72) Inventors: Jan-Kristian Markiewicz, Redmond, WA (US); Gerrit Hendrik Hofmeester, Woodinville, WA (US); Jon Gabriel Clapper, Seattle, WA (US); Adam George Barlow, Redmond, WA (US)

(73) Assignee: MICROSOFT CORPORATION, Redmond, WA (US)

(21) Appl. No.: 13/230,619

(22) Filed: Sep. 12, 2011

(51) Int. Cl. G06F 3/048

(52) U.S. Cl. 715/825

(57) ABSTRACT

A graphical user interface includes a collection of selectable content items, and a command surface for selectively displaying command selectors relating to the collection of selectable content items. Responsive to user selection of a first content item from the collection, the command surface is updated to include a first set of one or more command selectors applicable to the first content item. Responsive to user selection of a second content item, the command surface is updated to include a second set of one or more command selectors applicable to both the first content item and the second content item. Each command selector in the second set is selectable to execute a contextually applicable command related to both the first content item and the second content item.

### BACKGROUND

Graphical user interfaces allow computer users to view and interact with content such as pictures, emails, music, and videos. A user may apply a variety of commands to the content. The variability and numerosity of such commands may increase the complexity of the graphical user interface from the perspective of the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments relating to contextually applicable commands are disclosed. As one example, a graphical user interface is provided which includes a collection of selectable content items, and a command surface for selectively displaying command selectors relating to the collection of selectable content items.

Responsive to user selection of a first content item from the collection, the command surface may be updated to include a first set of one or more command selectors applicable to the first content item. Each command selector in the first set may be selectable to execute a contextually applicable command related to the first content item.

Responsive to user selection of a second content item, the command surface may be updated to include a second set of one or more command selectors applicable to both the first content item and the second content item. Each command selector in the second set may be selectable to execute a contextually applicable command related to both the first content item and the second content item.

### BRIEF DESCRIPTION OF THE DRAWINGS

FIG. 1 shows an example graphical user interface including a collection of selectable content items according to one disclosed embodiment.

FIG. 2 shows an example graphical user interface updated responsive to user selection of a first content item according to one disclosed embodiment.

FIG. 3 shows an example graphical user interface updated responsive to user selection of a second content item according to one disclosed embodiment.

FIG. 4 shows an example graphical user interface updated responsive to user de-selection of a previously selected content item according to one disclosed embodiment.

FIG. 5 shows a flow diagram depicting an example method of providing contextually applicable commands with a computing device according to one disclosed embodiment.

FIG. 6 is a schematic diagram depicting an example computing system according to one disclosed embodiment.

### DETAILED DESCRIPTION

Contextually applicable commands disclosed herein are presented by a graphical user interface (GUI) based on the particular combination of content items selected by a user. A user may execute a contextually applicable command related to each selected content item by selection of an individual command selector. Commands made available to the user may be added or removed from a command surface as a user selects additional content items or de-selects content items that were previously selected. Accordingly, less relevant commands may be hidden from view of the user, allowing the user to focus on more relevant commands for the content items actually selected by the user. These and other aspects of the disclosed contextually applicable commands are described below.

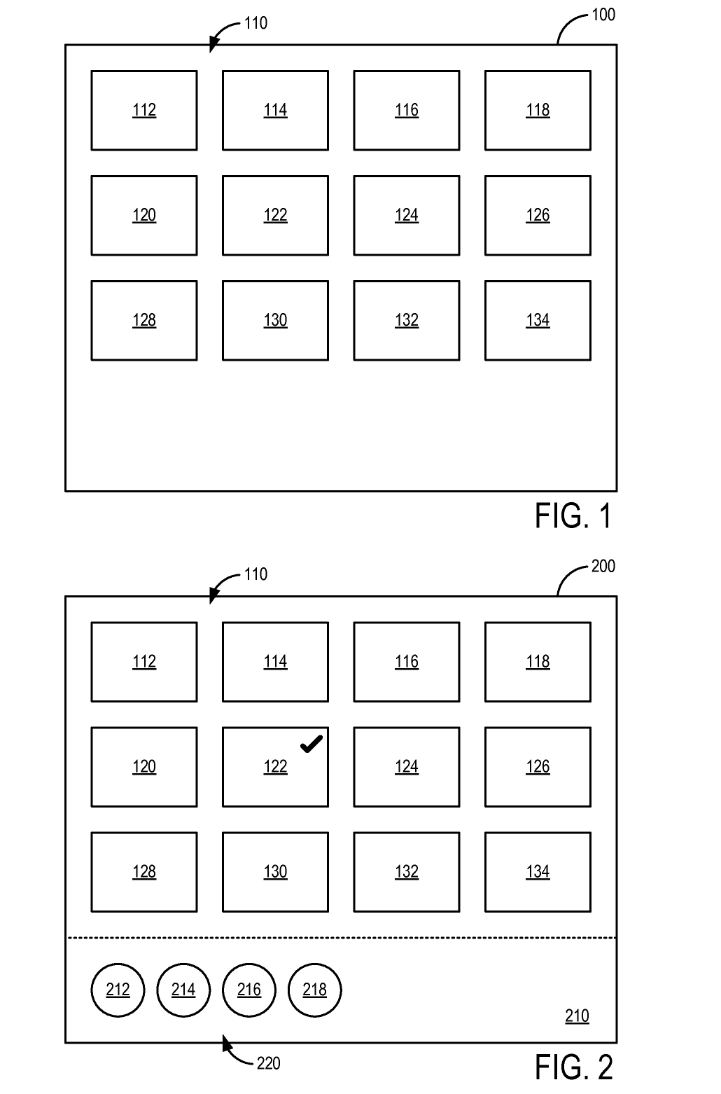

FIG. 1 shows an example graphical user interface (GUI) 100 including a collection 110 of selectable content items 112-134. The selectable content items of collection 110 may include one or more of: a video file, an audio file, an image file, an email message, a word processing document file, or a personal profile or contact information file, for example. The methods disclosed herein are applicable to virtually any type of content displayable by a computing system, including types beyond the examples provided above.

FIG. 2 shows an example GUI 200 updated from GUI 100 of FIG. 1 responsive to user selection of a first content item (e.g., content item 122). To select a content item, a user may, for example, tap or swipe (e.g., via a touch-screen) the content item, or left click (e.g., via a computer mouse) on the content item to add the content item to a set of selected content items. This selection process may again be repeated by the user to select other content items while previously selected content items remain selected. A user may select multiple content items through one or more selections to build a context for which contextually applicable commands may be presented to the user. This example approach is in contrast to other multi-selection schemes in which a different user input or command is used to select multiple items or to add new items to a previous selection of items.

GUI 200 includes a command surface 210 for selectively displaying zero or more command selectors relating to the collection of selectable content items. Responsive to user selection of a first content item (e.g., user content item 122), the graphical user interface may be updated to indicate the user selection. For example, content item 122 is depicted as including an indicator represented in FIG. 2 by a checkmark. Other suitable indicators may be used to visually indicate user selection of a content item. As nonlimiting examples, user selection of one or more content items may be indicated by highlighting or emphasizing the selected content items, by changing a color of the selected content items, by changing a color of the unselected content items, by changing a size of the selected content items relative to the unselected content items, and/or by adding, changing, or removing an indicator associated with selected content items to enable a user to distinguish the selected content items from the unselected content items.

Command surface 210 may also be updated responsive to user selection of the first content item to include a first set 220 of one or more command selectors (e.g., command selectors 212, 214, 216, 218) that are applicable to the first content item. Each command selector in first set 220 may be selectable to execute a contextually applicable command related to the first content item. For example, command selector 212 may be selectable to execute a print command and command selector 214 may be selectable to execute a copy command with respect to the first content item.

By presenting command selectors of contextually applicable commands while hiding command selectors of less applicable or inapplicable commands, the graphical user interface is simplified by reducing or eliminating command selectors that the user is unlikely to use with a given context. Command surface 210 may be presented in a consistent location of the graphical user interface, in some examples, to further provide the user with a predictable location on the graphical user interface where contextually applicable commands can be accessed by the user. Command surface 210 of FIG. 2 is also presented in the same view as the content items to enable the user to select additional content items or de-select previously selected content items while the command surface 210 is presented to the user.

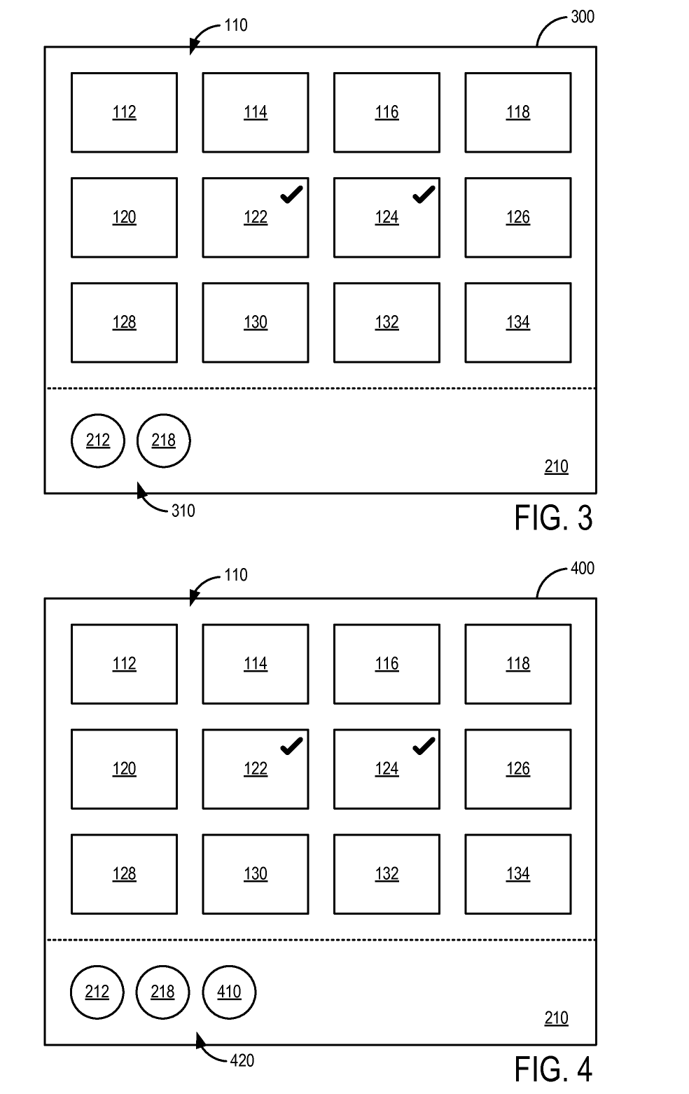

FIG. 3 shows an example graphical user interface 300 updated from GUI 200 of FIG. 2 responsive to user selection of a second content item (e.g., content item 124) according to one disclosed embodiment. In some implementations, user selection of a second content item may be achieved using the same user input or command that was used for selection of the first content item. For example, a user may tap or swipe (e.g., via a touch-screen), or left click (e.g., via a computer mouse) on the second content item to add the second content item to a set of selected content items. As previously discussed, this example approach may be in contrast to other multi-selection schemes in which a different user input or command is used to select multiple items or to add new items to a previous selection of items.

Responsive to user selection of the second content item, the graphical user interface may be updated to indicate user selection of both the first content item and the second content item. For example, content items 122 and 124 include indicators represented in FIG. 3 by checkmarks. Again, other suitable indicator may be used to indicate user selection of the one or more content items.

Command surface 210 may be updated responsive to the user selection of the second content item to include a second set 310 of one or more command selectors (e.g., 212, 218) applicable to both the first content item and the second content item. Each command selector in second set 310 may be selectable to execute a contextually applicable command related to both the first content item and the second content item.

For example, second set 310 is depicted with a reduced number of command selectors in relation to first set 220. Command selectors 212 and 218 may correspond to commands that are applicable to two or more content items, e.g., both the first content item and the second content item. In some examples, command selectors that correspond to commands involving an interaction between the first content item and the second content item may be added to the command surface. For example, the number of commands made available to a user may increase as additional content items are selected by the user.

FIG. 4 shows an example graphical user interface 400 updated from GUI 300 of FIG. 3 responsive to user de-selection of a previously selected content item (e.g., content item 122). In some implementations, de-selection of a previously selected content item may use the same user input or command from a user input or command that was used to select the content item. For example, a user may tap or left click to select a content item and may tap or left click again to de-select the content item. In other implementations, de-selection of a previously selected content item may use a different command from a user input or command that was used to select the content item. For example, a user may tap or left click to select a content item, and may swipe or right click to de-select a content item.

Responsive to user de-selection, for example, of the previously selected first content item (e.g., content item 122), the graphical user interface may be updated to remove an indication of user selection of the first content item while maintaining an indication of user selection of the second content item. For example, the checkmark depicted in FIGS. 2 and 3 for content item 122 has been removed in FIG. 4 responsive to de-selection of content item 122.

Command surface 210 may be updated responsive to user de-selection of the first content item to include a third set 420 of one or more command selectors (e.g., command selectors 212, 218, 410) applicable to the second content item. For example, an additional command selector 410 has been added to command surface 210. Each command selector in third set 420 may be selectable to execute a contextually applicable command related to the second content item.

In some implementations, if all content items are de-selected by the user, then the command surface may be hidden or otherwise removed from the graphical display, such as depicted in GUI 100 of FIG. 1, for example. In other implementations, the command surface may remain or may continue to be presented to the user even after all content items have been de-selected by the user.

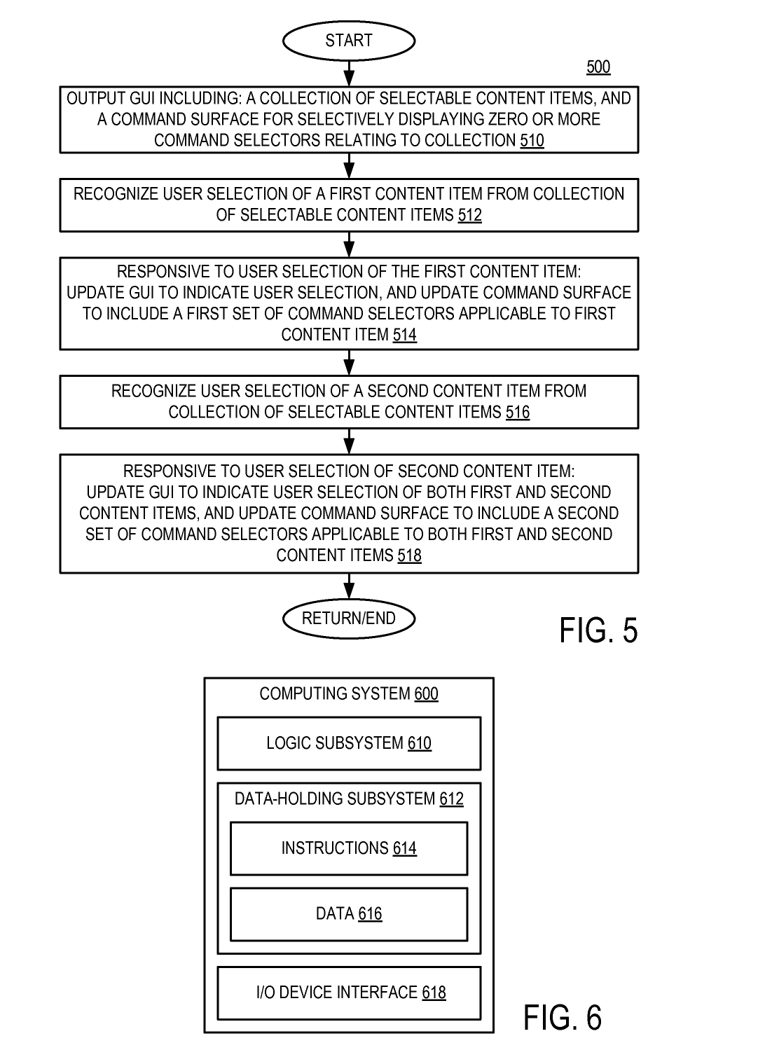

FIG. 5 shows a flow diagram depicting an example method 500 of providing contextually applicable commands with a computing device.

At 510, the method may include outputting a graphical user interface for presentation via a graphical display device. As previously discussed, the graphical user interface may include a collection of selectable content items, and a command surface for selectively displaying zero or more command selectors relating to the collection of selectable content items.

In some implementations, the command surface may selectively display zero command selectors relating to the collection of selectable content items prior to the user selection of a first content item. For example, one or more commands may be initially hidden from view prior to the user selecting a content item. In other implementations, the command surface may display one or more command selectors prior to selection of a first content item. Command selectors displayed prior to the selection of a first content item may be referred to as context-independent commands. Examples of context-independent commands may include a select-all command or a clear-all command that may be applied to aid in the selection or de-selection of content items.

In some embodiments, the command surface and/or command selectors within the command surface may be displayed but disabled (e.g., grayed out). The entire command surface may be disabled if no command selectors are currently available, for example. Additionally and/or alternatively, individual command selectors may be disabled if those command selectors do not apply to a current context.

At 512, the method may include recognizing a user selection of a first content item from the collection of selectable content items. For example, a user input may be received via a user input device such as a computer mouse, touch-screen, keyboard, controller, optical sensor system, etc. indicating a user selection of one or more content items. A user selection may be indicated, for example, by a tap or a click at or on a content item. A mouse click may correspond to a right click or a left click, for example. A user selection may be indicated by a swipe command, such as where a user input is directed at the content item and then translated away from an initial point of contact.

In some implementations, at 510 the method may include, prior to user selection of a first content item, outputting the graphical user interface including the collection of selectable content items without including the command surface. For example, FIG. 1 initially depicts a graphical user interface without a command surface. Responsive to user selection of at least the first content item at 512, the method may further include outputting the graphical user interface including the command surface.

At 514, responsive to user selection of the first content item, the method may include updating the graphical user interface to indicate user selection of the first content item, and updating the command surface to include a first set of one or more command selectors applicable to the first content item. By this example, a single user input or command is used to both select the first content item and to initiate presentation of a command surface having commands that are applicable to the particular selection. This example approach is in contrast to other selection schemes that rely instead on separate user inputs or commands for selecting a content item and for accessing a command menu.

Each command selector in the first set may be selectable to execute a contextually applicable command related to the first content item. Some example commands include copy, cut, delete, paste, print, merge, reply, reply-to-all, add-to-contacts, play, pause, etc. It will be appreciated that any suitable command or combination of commands may be exposed to the user based, at least in part, on context and the combination of content items selected by the user. One or may commands may have influence on the selection of content items, e.g., “select all” or “deselect all.”

In some implementations, the command surface may selectively display one or more initial command selectors relating to the collection of selectable content items prior to user selection of the first content item. As one example, the method may include updating the command surface responsive to user selection of the first content item by replacing and/or removing one or more initial command selectors with the first set of one or more command selectors applicable to the first content item. Additionally or alternatively, the method may include updating the command surface responsive to user selection of the first content item by adding the first set of one or more command selectors applicable to the first content item to the command surface with the one or more initial command selectors.

In some implementations, responsive to user selection of the first content item, the method at 514 may include filtering a pool of available commands based on a characteristic of the first content item to obtain the first set of one or more command selectors applicable to the first content item. As one example, a characteristic of a content item may include a type of content, such as whether the content item is a video, an image, an email message, a word processing document, etc.

At 516, the method may include recognizing a user selection of a second content item from the collection of selectable content items. For example, another user input may be received via a user input device indicating another user selection of one or more additional content items.

At 518, responsive to user selection of the second content item, the method may include updating the graphical user interface to indicate user selection of both the first content item and the second content item, and updating the command surface to include a second set of one or more command selectors applicable to both the first content item and the second content item. Each command selector in the second set may be selectable to execute a contextually applicable command related to both the first content item and the second content item.

In some implementations, responsive to user selection of the second content item, the method at 518 may include further filtering the pool of available commands based on a characteristic of the first content item and based on a characteristic of the second content item to obtain the second set of one or more command selectors applicable to both the first content item and the second content item. As previously discussed, a characteristic of a content item may include a type of content, for example.

As one example, the second set of one or more command selectors may include at least the first set of one or more command selectors, and may include at least one or more additional command selectors. As another example, the second set of one or more command selectors may include a subset of the first set of one or more command selectors, whereby one or more command selectors are removed from the first set to obtain the second set. The command selectors that are presented via the command surface are executable on the selected content items and/or in the current context created by the particular selection of content items. Superfluous or inapplicable commands, such as commands that are not executable on the selected content items and/or particular content are omitted from the command surface.

The method may further include recognizing a user selection of a command selector from the second set of one or more command selectors. Responsive to the user selection of the command selector, the method may further include executing the contextually applicable command of the command selector with respect to both the first content item and the second content item. For example, if a command selector corresponding to a print command is selected, then the print command may be executed with respect to both the first and second selected content items.

In some examples, a particular selection of content items may persist so that content items may remain selected even after a command has been executed on those selected content items. In other examples, previous selections may be cleared or de-selected after a command is executed on some or all of those content items. As previously discussed, the command surface may be removed from the graphical user interface or otherwise hidden from view in some examples if all content items are de-selected by the user or cleared in response to execution of a command.

In at least some implementations, prior to the user selection of the second content item, the method may include recognizing a user selection of a command selector from the first set of one or more command selectors. The method may then include executing the contextually applicable command of the command selector with respect to the first content item responsive to the user selection of the command selector. After the command has been executed with respect to the first content item, the user may select one or more additional content items, such as the second content item to which further commands may be applied.

The methods described herein are applicable to further user selections of content items. For example, the method may include recognizing a user selection of a third content item from the collection of selectable content items. Responsive to user selection of the third content item, the method may include updating the graphical user interface to indicate user selection of all of the first content item, the second content item, and the third content item. The method may further include updating the command surface to include a third set of one or more command selectors applicable to the first content item, the second content item, and the third content item. Each command selector in the third set may be selectable to execute a contextually applicable command related to the first content item, the second content item, and the third content item.

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included herein are schematic and generally not drawn to scale. Rather, the various drawing scales, aspect ratios, and numbers of components shown in the figures may be purposely distorted to make certain features or relationships easier to see.

In some embodiments, the above described methods and processes may be tied to a computing system including one or more computers. In particular, the methods and processes described herein may be implemented as a computer application, computer service, computer API, computer library, and/or other computer program product.

FIG. 6 schematically shows a nonlimiting computing system 600 that may perform one or more of the above described methods and processes. Computing system 600 is shown in simplified form. It is to be understood that virtually any computer architecture may be used without departing from the scope of this disclosure. In different embodiments, computing system 600 may take the form of a mainframe computer, server computer, desktop computer, laptop computer, tablet computer, home entertainment computer, network computing device, mobile computing device, mobile communication device, gaming device, etc.

Computing system 600 includes a logic subsystem 610 and a data-holding subsystem 612. Computing system 600 may optionally include a display subsystem, communication subsystem, and/or other components not shown in FIG. 6. Computing system 600 may also optionally include user input devices such as keyboards, mice, game controllers, cameras, microphones, and/or touch screens, for example. The display subsystem, communication subsystem, and/or user input devices may communicate with computing system 600 via input/output interface 618.

Logic subsystem 610 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 612 may include one or more physical, non-transitory, devices configured to hold data and/or instructions executable by the logic subsystem to implement the herein described methods and processes. When such methods and processes are implemented, the state of data-holding subsystem 612 may be transformed (e.g., to hold different data).

Data-holding subsystem 612 may include removable media and/or built-in devices. Data-holding subsystem 612 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 612 may include devices with one or more of the following characteristics: volatile, nonvolatile, dynamic, static, read/write, read-only, random access, sequential access, location addressable, file addressable, and content addressable. In some embodiments, logic subsystem 610 and data-holding subsystem 612 may be integrated into one or more common devices, such as an application specific integrated circuit or a system on a chip.

Aspect of the data-holding subsystem may take the form of removable computer-readable storage media, which may be used to store and/or transfer data and/or instructions executable to implement the herein described methods and processes. Removable computer-readable storage media may take the form of CDs, DVDs, HD-DVDs, Blu-Ray Discs, EEPROMs, and/or floppy disks, among others.

It is to be appreciated that data-holding subsystem 612 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

When included, a display subsystem may be used to present a visual representation of data held by data-holding subsystem 612. As the herein described methods and processes change the data held by the data-holding subsystem, and thus transform the state of the data-holding subsystem, the state of the display subsystem may likewise be transformed to visually represent changes in the underlying data. The display subsystem may include one or more display devices utilizing virtually any type of technology. Such display devices may be combined with logic subsystem 610 and/or data-holding subsystem 612 in a shared enclosure, or such display devices may be peripheral display devices.

When included, a communication subsystem may be configured to communicatively couple computing system 600 with one or more other computing devices. The communication subsystem may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 600 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A data-holding subsystem holding instructions executable by a logic subsystem to:
output a graphical user interface for presentation via a graphical display device, the graphical user interface including:
a collection of selectable content items, and a command surface for selectively displaying zero or more command selectors relating to the collection of selectable content items;
recognize a user selection of a first content item from the collection of selectable content items;
responsive to user selection of the first content item:
update the graphical user interface to indicate user selection of the first content item; and
update the command surface to include a first set of one or more command selectors applicable to the first content item, each command selector in the first set selectable to execute a contextually applicable command related to the first content item;
recognize a user selection of a second content item from the collection of selectable content items; and
responsive to user selection of the second content item:
update the graphical user interface to indicate user selection of both the first content item and the second content item; and
update the command surface to include a second set of one or more command selectors applicable to both the first content item and the second content item, each command selector in the second set selectable to execute a contextually applicable command related to both the first content item and the second content item.

2. The data-holding subsystem of claim 1, wherein the instructions are further executable by the logic subsystem to:
recognize a user selection of a command selector from the second set of one or more command selectors; and
execute the contextually applicable command of the command selector with respect to both the first content item and the second content item responsive to the user selection of the command selector.

3. The data-holding subsystem of claim 1, wherein the instructions are further executable by the logic subsystem to:
prior to the user selection of the second content item, recognize a user selection of a command selector from the first set of one or more command selectors; and
execute the contextually applicable command of the command selector with respect to the first content item responsive to the user selection of the command selector.

4. The data-holding subsystem of claim 1, wherein the command surface selectively displays one or more initial command selectors relating to the collection of selectable content items prior to user selection of the first content item.

5. The data-holding subsystem of claim 4, wherein the instructions are further executable by the logic subsystem to update the command surface responsive to user selection of the first content item by replacing the one or more initial command selectors with the first set of one or more command selectors applicable to the first content item.

6. The data-holding subsystem of claim 4, wherein the instructions are further executable by the logic subsystem to update the command surface responsive to user selection of the first content item by adding the first set of one or more command selectors applicable to the first content item to the command surface with the one or more initial command selectors.

7. The data-holding subsystem of claim 1, wherein the command surface selectively displays zero command selectors relating to the collection of selectable content items prior to the user selection of the first content item.

8. The data-holding subsystem of claim 1, wherein the instructions are further executable by the logic subsystem to:
prior to user selection of the first content item, output the graphical user interface including the collection of selectable content items without including the command surface; and
responsive to user selection of the first content item, output the graphical user interface including the collection of selectable content items and the command surface including the first set of one or more command selectors applicable to the first content item.

9. The data-holding subsystem of claim 1, wherein the second set of one or more command selectors includes at least the first set of one or more command selectors, and includes at least one or more additional command selectors.

10. The data-holding subsystem of claim 1, wherein the second set of one or more command selectors includes a subset of the first set of one or more command selectors.

11. The data-holding subsystem of claim 1, wherein the instructions are further executable by the logic subsystem to:
responsive to user selection of the first content item, filter a pool of available commands based on a characteristic of the first content item to obtain the first set of one or more command selectors applicable to the first content item; and
responsive to user selection of the second content item, further filter the pool of available commands based on a characteristic of the first content item and based on a characteristic of the second content item to obtain the second set of one or more command selectors applicable to both the first content item and the second content item.

12. The data-holding subsystem of claim 1, wherein the instructions are further executable by the logic subsystem to:
recognize a user selection of a third content item from the collection of selectable content items; and
responsive to user selection of the third content item:
update the graphical user interface to indicate user selection of all of the first content item, the second content item, and the third content item; and
update the command surface to include a third set of one or more command selectors applicable to the first content item, the second content item, and the third content item, each command selector in the third set selectable to execute a contextually applicable command related to the first content item, the second content item, and the third content item.

13. The data-holding subsystem of claim 1, wherein the instructions are further executable by the logic subsystem to:
recognize a user de-selection of the first content item from the collection of selectable content items;
responsive to user de-selection of the first content item:
update the graphical user interface to remove an indication of user selection of the first content item while maintaining an indication of user selection of the second content item; and
update the command surface to include a third set of one or more command selectors applicable to the second content item, each command selector in the third set selectable to execute a contextually applicable command related to the second content item.

14. The data-holding subsystem of claim 1, wherein the selectable content items of the collection include one or more of: a video file, an audio file, an image file, an email message, or a document file.

15. A method of providing contextually applicable commands with a computing device, comprising:
outputting a graphical user interface for presentation via a graphical display device, the graphical user interface including:
a collection of selectable content items, and
a command surface for selectively displaying zero or more command selectors relating to the collection of selectable content items;
recognizing a user selection of a first content item from the collection of selectable content items;
responsive to user selection of the first content item:
updating the graphical user interface to indicate user selection of the first content item; and
updating the command surface to include a first set of one or more command selectors applicable to the first content item, each command selector in the first set selectable to execute a contextually applicable command related to the first content item;
recognizing a user selection of a second content item from the collection of selectable content items; and
responsive to user selection of the second content item:
updating the graphical user interface to indicate user selection of both the first content item and the second content item;
updating the command surface to include a second set of one or more command selectors applicable to both the first content item and the second content item, each command selector in the second set selectable to execute a contextually applicable command related to both the first content item and the second content item;
recognizing a user selection of a command selector from the second set of one or more command selectors; and
executing the contextually applicable command of the command selector with respect to both the first content item and the second content item responsive to the user selection of the command selector.

16. The method of claim 15, wherein updating the command surface to include the second set of one or more command selectors further comprises:
updating the command surface by adding one or more additional command selectors to the first set; and/or
updating the command surface by removing one or more command selectors from the first set to obtain the second set.

17. The method of claim 15, further comprising:
recognizing a user de-selection of the first content item from the collection of selectable content items;
responsive to user de-selection of the first content item:
updating the graphical user interface to remove an indication of user selection of the first content item while maintaining an indication of user selection of the second content item; and
updating the command surface to include a third set of one or more command selectors applicable to the second content item, each command selector in the third set selectable to execute a contextually applicable command related to the second content item.

18. The method of claim 15, further comprising:
prior to user selection of the first content item, outputting the graphical user interface including the collection of selectable content items without including the command surface; and
responsive to user selection of the first content item, outputting the graphical user interface including the collection of selectable content items and the command surface including the first set of one or more command selectors applicable to the first content item.

19. A method of providing contextually applicable commands with a computing device, comprising:
outputting a graphical user interface for presentation via a graphical display device, the graphical user interface including:
a collection of selectable content items, and
a command surface for selectively displaying zero or more command selectors relating to the collection of selectable content items;
recognizing a user selection of a first content item from the collection of selectable content items;
responsive to user selection of the first content item:
updating the graphical user interface to indicate user selection of the first content item; and
updating the command surface to include a first set of one or more command selectors applicable to the first content item, each command selector in the first set selectable to execute a contextually applicable command related to the first content item;
recognizing a user selection of a second content item from the collection of selectable content items; and
responsive to user selection of the second content item:
updating the graphical user interface to indicate user selection of both the first content item and the second content item; and
updating the command surface to include a second set of one or more command selectors applicable to both the first content item and the second content item by adding one or more additional command selectors to the first set and/or by removing one or more command selectors from the first set, each command selector in the second set selectable to execute a contextually applicable command related to both the first content item and the second content item.

20. The method of claim 19, further comprising:
recognizing a user de-selection of the first content item from the collection of selectable content items;
responsive to user de-selection of the first content item:
updating the graphical user interface to remove an indication of user selection of the first content item; and
updating the command surface to include a third set of one or more command selectors applicable to the second content item, each command selector in the third set selectable to execute a contextually applicable command related to the second content item.
